(19) United States
(12) Patent Application Publication
(10) Pub. No.: US 2026/0106932 A1
(43) Pub. Date: Apr. 16, 2026

(54) METHOD AND SYSTEM FOR RESTRICTING SMART DEVICE CAMERA USE

(71) Applicant: Imam Abdulrahman Bin Faisal University, Dammam (SA)

(72) Inventors: Alaa Yahya ALAHMADI, Dammam (SA); Abdullah Saeed ALMURAYH, Dammam (SA); Jumana Abdulrahman ALSHEHRI, Dammam (SA); Noor Fathi ALNASSER, Dammam (SA); Zahraa Yousef ALTURAIKI, Dammam (SA); Reman Abdulrazaq ALOMAR, Dammam (SA); Hams Ali ALSHEHRI, Dammam (SA)

(73) Assignee: Imam Abdulrahman Bin Faisal University, Dammam (SA)

(21) Appl. No.: 18/917,616

(22) Filed: Oct. 16, 2024

(51) Int. Cl. H04M 1/72457

(52) U.S. Cl. CPC H04M 1/72457

(57) ABSTRACT

A system for restricting camera use in a photography prohibited zone includes signal transmission devices configured to broadcast a control signal at a specified distance to notify a client smart device that the client smart device has entered the photography prohibited zone. The control signal requires turning off of camera function on the client smart device. The system further includes an administration device configured to activate the signal transmission devices, set the specified distance that each of the plurality of transmission broadcasts the control signal in order to define a boundary of the photography prohibited zone. The administration device sets day, time, and period in which the photography prohibited zone is considered active, and interacts with a backend server. The backend server is configured to authenticate the administration device and the signal transmission devices, manage operation of the administration device, save and analyze system data, and control system security.

### BACKGROUND

### Technical Field

The present disclosure is directed towards privacy protection technologies, and more particularly, directed towards a system for restricting camera use and a method thereof.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Privacy has increasingly become a significant problem in today's world. As systems advance technically, proper measures must be implemented to protect privacy of people and prevent unauthorized digital activity, especially in certain private zones. With the advent of semiconductors, smart devices have become abundant and smart devices are being equipped with recording devices. These devices contain sensory and communication components that can result in an invasion of privacy, such as the camera attached to smart devices, including smartphones, tablets, and other mobile camera equipped devices. The widespread use of cameras raises privacy invasion concerns, particularly in private zones or conference rooms since it may result in unauthorized capture and disemination of sensitive information. Further, places like schools prohibit using phones, private art museums do not allow photography due to copyright issues, parents fear privacy issues when their children excessively use smart devices without supervision or control. Accordingly, there is a need for a solution to allow the use of smart devices while ensuring privacy is protected by restricting camera use in certain zones. As such, strong policies against invasion of privacy must be implemented to ensure that people's privacy is upheld and protected. Therefore, there is a need for system that effectively stops the camera functionality within the restricted zones by employing Internet of Things (IoT) technology. In some cases, IoT devices with small physical footprint, such as wireless signal podcasting devices may indicate the surrounding smart devices with appropriate receivers, such as cameras or cell phones.

Almurayh et al. [See: Almurayh, A., Alshaeri, O., Alghadeer, N., Alyousef, R., Alshehri, R., Al-Hajri, S., & Farooqui, M. (2021). IoQZ: An Implementation of a Quiet Zone. IEEE Internet of Things Journal, 9(11), 8800-8808] proposed a solution for implementing an environment with a predetermined perimeter known as the “quiet zone” to avoid potential disturbance of the frequent sounds of notifications smart phones produces throughout the day. The implementation of a quiet zone employs the concept of IoT by utilizing unique Bluetooth low-energy (BLE) transmitters, which indicate that a smartphone has entered the proximity of a quiet zone. Further, the smartphone may dynamically interact with the transmitters based on the user's locality. Therefore, when a phone enters a quiet zone, it automatically sets itself to silent mode to turn off ringtones. Conversely, the phone sets back to the previous mode once it departs the quiet zone range. However, the above publication does not describe disabling audio and video recording devices.

Hasan et al. [See: R. Hasan, M.A. Hoque, Y. Karim, R. Griffin, D. Schwoebel, and R. Hasan, “Smartphone-based Distracted Pedestrian Localization using Bluetooth Low Energy Beacons,” IEEE Xplore, Mar. 1, 2020, Accessed Sep. 8, 2023.] developed a smartphone based system utilizing BLE beacons to enhance pedestrian safety by alerting distracted individuals while crossing intersections. The system successfully detects users' distractions through sensor data analysis and accurately locates pedestrians within the intersection using received signal strength indicators (RSSI) values. With 14 strategically placed beacons, the system achieved a detection distance of 65 meters. It is designed to be compatible with both android or iOS platforms. However, the above publication does not describe audio or video recording devices.

The above described publications still do not provide solutions for privacy concerns in private zones. Accordingly, it is one object of the present disclosure to provide a system for restricting camera use in mobile devices and a method thereof in zones that require privacy.

### SUMMARY

In an exemplary embodiment, a system for restricting camera use in a photography prohibited zone is described. The system includes a plurality of signal transmission devices configured to broadcast a control signal, at a specified distance to notify a client smart device that the client smart device has entered the photography prohibited zone, wherein the control signal requires turning off of camera function on the client smart device; an administration device configured to activate the plurality of signal transmission devices to broadcast the control signal, set the specified distance that each of the plurality of signal transmission devices broadcasts the control signal in order to define a boundary of the photography prohibited zone, set day, time, and period in which the photography prohibited zone is considered active, and interact with a backend server; and wherein the backend server is configured to authenticate the administration device and the plurality of signal transmission devices, manage operation of the administration device, save and analyze system data, and control system security.

In some embodiments, the administration device is configured to transmit a search signal for a relevant signal transmission device that is relevant only to the system, detect a response signal to the search signal and verify reliability of the relevant signal transmission device through a verification mechanism, add the relevant signal transmission device within a range of the administration device so that the relevant signal transmission device begins to receive command signals from the administration device.

In some embodiments, the administration device is configured to delete one signal transmission device among the plurality of signal transmission devices such that the one signal transmission device stops broadcasting control signals.

In some embodiments, the administration device is configured to monitor the plurality of signal transmission devices, including detecting their activity level, and battery level.

In some embodiments, the system further the client smart device configured with a mobile application to permit interaction with a signal transmission device of the plurality of the signal transmission devices, including scan for the control signal from the signal transmission device, when the control signal is detected indicating the photography prohibited zone, disable the camera function on the client smart device, display a notification that the camera function has been disabled, when the control signal indicates that the client smart device is exiting the photography prohibited zone, reactivate the camera function and display a notification that the camera function has been reactivated.

In some embodiments, at least one of the plurality of signal transmission devices is mounted such that it is hidden from view by a user of the client smart device.

In some embodiments, the plurality of signal transmission devices is configured to broadcast a low energy control signal including a notification to alert a pedestrian user of the client smart device that a private zone has been entered where camera usage is prohibited.

In some embodiments, the administration device is further configured to monitor status of the plurality of signal transmission devices to include transmission of a switching command signal for switching to different photography prohibited zones.

In some embodiments, the administration device is further configured to transmit a power command signal to turn on and off subsets of the plurality of signal transmission devices for different photography prohibited zones.

In some embodiments, the administration device is further configured to transmit a scheduling command signal to turn on and off the subsets of the plurality of signal transmission devices according to a schedule of time periods.

In another exemplary embodiment, a method of restricting camera use in a photography prohibited zone is described. The method includes broadcasting, by at least one signal transmission device, a control signal at a specified distance to notify a client smart device that the client smart device has entered the photography prohibited zone, wherein the control signal that requires turning off of camera function on the smart client device; activating, by an administration device, the at least one signal transmission device to broadcast the control signal; setting, by the administration device, the specified distance that the at least one signal transmission device broadcasts the control signal in order to define a boundary of the photography prohibited zone; setting, by the administration device, day, time, and period in which the photography prohibited zone is considered active; interacting, by the administration device, with a backend server; authenticating, by the backend server, the administration device and the at least one signal transmission device; managing, by a backend server, operation of the administration device; saving and analyzing system data, by the backend server; and controlling, by the backend server, system security.

In some embodiments, the method further includes transmitting, by the administration device, a search signal for a relevant signal transmission device that is relevant only to the photography prohibited zone; when a response signal is detected, verifying, by the administration device, reliability of the relevant signal transmission device through a verification mechanism; and adding, by the administration device, the relevant signal transmission device within a range of the administration device so that the relevant signal transmission device begins to receive command signals from the administration device.

In some embodiments, the method further includes deleting, by the administration device, one signal transmission device from the at least one signal transmission device.

In some embodiments, the method further includes monitoring, by the administration device, the at least one signal transmission devices, including detecting their activity level, and battery level.

In some embodiments, the method further includes permitting interaction between the client smart device, by way of a mobile application, with the at least one signal transmission devices, including scanning for the control signal from a signal transmission device of the at least one signal transmission device; when the control signal is detected indicating the photography prohibited zone, disabling, by the administration device, the camera function on the client smart device; displaying, in the administration device, notification that the camera function has been disabled; and when the control signal indicates that the client smart device is exiting the photography prohibited zone, reactivate the camera function and display a notification that the camera function has been reactivated.

In some embodiments, the at least one signal transmission device is mounted such that it is hidden from view by a user of the client smart device.

In some embodiments, the method further includes broadcasting, by the at least one signal transmission device, the control signal as a low energy control signal.

In some embodiments, the method further includes monitoring, by the administration device, status of the at least one signal transmission device including transmission of a switching command signal for switching to different photography prohibited zones.

In some embodiments, the method further includes transmitting a power command signal to turn on and off, by the administration device, subsets of the at least one signal transmission device for different photography prohibited zones.

In some embodiments, the method further includes transmitting a scheduling command signal to turn on and off, by the administration device, the subsets of the at least one signal transmission device according to a schedule of time periods.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 illustrates a schematic block diagram of a system for restricting camera use, according to certain embodiments;

FIG. 2A illustrates a schematic flow diagram of a method for restricting camera use, according to certain embodiments;

FIG. 2B illustrates a flowchart depicting interaction of the system of FIG. 1 with a client smart device, according to certain embodiments;

FIG. 3 illustrates a schematic block diagram depicting an exemplary architecture of the system of FIG. 1, according to certain embodiments;

FIG. 4A illustrates a schematic block diagram of a system architecture for client and enterprise use, according to certain embodiments;

FIG. 4B illustrates a flowchart of a method of installation of an administration software on an administration device, according to certain embodiments;

FIG. 5 illustrates a flow diagram of a method for adding signal transmission devices to the system of FIG. 1, according to certain embodiments;

FIG. 6A illustrates an exemplary user interface displaying a new administrator registration screen, according to certain embodiments;

FIG. 6B illustrates the exemplary user interface displaying a login screen, according to certain embodiments;

FIG. 6C illustrates the exemplary user interface displaying a main admin screen, according to certain embodiments;

FIG. 6D illustrates the exemplary user interface displaying an account screen, according to certain embodiments;

FIG. 6E illustrates the exemplary user interface displaying a control screen, according to certain embodiments;

FIG. 6F illustrates the exemplary user interface displaying a technical screen, according to certain embodiments;

FIG. 6G illustrates the exemplary user interface displaying a service screen for a client smart device, according to certain embodiments;

FIG. 6H illustrates the exemplary user interface displaying a control and support screen for a client smart device, according to certain embodiments;

FIG. 6I illustrates the exemplary user interface displaying a notification screen for a client smart device, according to certain embodiments;

FIG. 6J illustrates the exemplary user interface displaying a locked device notification screen for a client smart device, according to certain embodiments;

FIG. 6K illustrates the exemplary user interface displaying a lock screen requiring a security key for a client smart device, according to certain embodiments;

FIG. 7 is an illustration of a non-limiting example of details of computing hardware used in a computing system of the system for restricting camera use, in accordance with certain embodiments;

FIG. 8 is an exemplary schematic diagram of a data processing system used within the computing system, in accordance with certain embodiments;

FIG. 9 is an exemplary schematic diagram of a processor used with the computing system, in accordance with certain embodiments; and

FIG. 10 is an illustration of a non-limiting example of distributed components which may share processing with a controller, in accordance with certain embodiments.

### DETAILED DESCRIPTION

In the drawings, like reference numerals designate identical or corresponding parts throughout the several views. Further, as used herein, the words “a,” “an” and the like generally carry a meaning of “one or more,”unless stated otherwise.

Furthermore, the terms “approximately,” “approximate,” “about,” and similar terms generally refer to ranges that include the identified value within a margin of 20%, 10%, or preferably 5%, and any values therebetween.

Aspects of this disclosure are directed towards a system for restricting camera use in a photography/videography prohibited zone and a method of implementation thereof. The system as provided herein aims to provide solutions for dealing with known and hidden security and privacy concerns including providing protection against unauthorized camera use of smart devices in private zones. By leveraging synergistic qualities of Bluetooth low-energy beacons and computing software, as provided in the present disclosure, camera use may be restricted to a certainty at low costs. Further, persons responsible for managing places may manage privacy zones in those places and better and more confidentially. The present disclosure further informs owners of smart devices that they are entering a private zone. In addition, the system and the method provided in the present disclosure can be retrofitted into existing facilities to manage private zones.

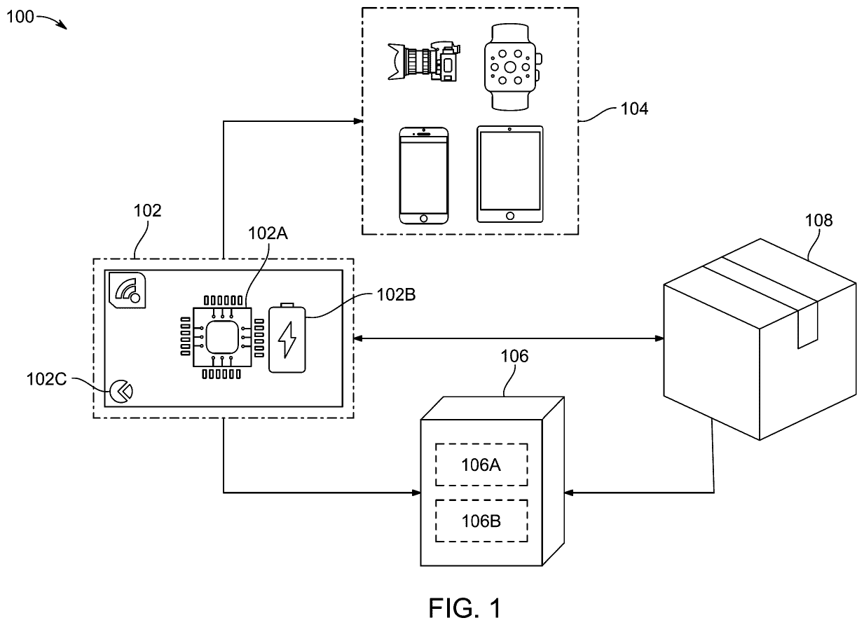

Referring to FIG. 1, a schematic block diagram of a system 100 for restricting camera use is illustrated, according to certain embodiments. In particular, FIG. 1 illustrates a plurality of components included in the system 100 in order to realize the system 100 for use at an area of employment of the system 100. In some embodiments, the system 100 includes one or more signal transmission devices 102 and a client smart device 104. A person of ordinary skill in the art will understand that the signal transmission devices 102 may be collectively referred to as the signal transmission devices 102, and individually referred to as the signal transmission device 102. Further, the client smart device 104 may be alternatively referred to as the smart device 104 in case of individual devices and smart devices 104 in case of multiple devices, for the sake of brevity in explanation. In general, the signal transmission device refers to any electronic component capable of transmitting a digital or an analog signal. In a preferred embodiment, the signal transmission devices 102 refers to Bluetooth low energy (BLE) enabled devices. BLE is a wireless personal area network (PAN) technology configured to provide solutions for healthcare, fitness, beacons, security, and home entertainment industries. BLE is intended to provide considerably reduced power consumption and operational costs as compared to traditional Bluetooth technology, while maintaining a similar communication range. Further, the signal transmission devices 102 may be constructed in the form of a BLE wireless beacon. A Bluetooth beacon is a device used to send a packet of information that contains a Universally Unique Identifier (UUID). This UUID is used to trigger events specific to that beacon.

The signal transmission device 102, in general, is a device that transmits signals that comply with international standards for communications and networks. The signal transmission device 102 operates at low energy consumption (approximately 10 to 100 milliwatts) and the processing and storage processes are relatively minimal (e.g., a field programmable gate array or microcontroller). The signal transmission device 102 is configured with software that automatically recognizes a signal (e.g., Bluetooth Low Energy) that indicates a zone that is subject to photography restrictions.

In some embodiments, the signal transmission device 102 includes a microcontroller 102A in order to provide signal transmission and reception capabilities to the signal transmission device 102, a battery 102B configured to provide power to the signal transmission device 102, and a reset button 102C in order to provide resetting functionality to the signal transmission device 102 in case of a factory reset of the signal transmission device 102. Each of the signal transmission devices 102 are configured with an interactive component to broadcast a signal at a specified distance as specified by a responsible person to define the scope of the private zone boundary. The broadcast signal can include a notification message to a smart device that a zone of a specified boundary requires stopping the use of the smart devices' camera function. In other words, each of the signal transmission devices 102 broadcast a specific signal to the smart devices 104 at a specified distance from the signal transmission devices 102, in order to alert the smart devices 104 and their respective users of the zone boundary which prohibits camera use. In an exemplary embodiment, the signal transmission devices 102 are configured to broadcast an energy signal at a predetermined power, to alert a pedestrian user that a private zone has been entered where camera usage is prohibited. In some aspects, the signal transmission devices 102 may include simple information such as standards for the place's use policy where the signal transmission devices 102 are installed. In an example, the signal transmission devices 102 may be customized by adding information pertaining to the day, time, and period in which the zone is considered a no camera zone. Furthermore, at least one of the signal transmission devices 102 is mounted such that it is hidden from view by a user of the smart device 104. In other words, the signal transmission devices 102 are installed out of plain sight in order to protect any external factor from disrupting the sanctity of the system 100, further, to keep the signal transmission devices 102 out of sight so that no user may alter their positioning or reset the signal transmission devices 102 via the reset button 102C.

In some embodiments, the client smart device 104 is configured to interact with the signal transmission device 102, including scan for a signal from the signal transmission device 102. The smart device 104 may refer to any computing device which includes a camera and is portable. In some examples, the smart device 104 may refer to an android smartphone, an iOS smartphone, an android tablet, an iOS tablet, a portable media player, and the like. In some examples, when a scan signal is detected indicating a zone where photography is prohibited, the system 100 disables the camera function in the smart device 104. Further, the smart device 104 displays a notification that the smart device 104 has entered a private zone and the camera function is to be disabled by the user of the smart device 104. In some examples, when the scan signal indicates that the client smart device 104 is exiting the private zone, the system 100 notifies the user that the camera function can be re-enabled, and when enabled displays a notification that the camera function has been reactivated on the smart device 104 of the user.

In one embodiment, the user of the client smart device 104 can be required to install a mobile application (App) prior to entry to a venue having one or more private zones. Upon installing the App, the user acknowledges permission for the App to have access to the camera function. The App is configured to control the camera function by commands received using Bluetooth communication. The App is also configured to detect Bluetooth signals and establish a link with a nearby signal transmission device 102. Upon receiving a control command from a signal control device 102, the App can turn on or off the camera function of the client smart device 104.

The App may include other features, such as ticket purchase for entry to the venue, payment for purchases at the venue, listening to audio recordings while touring the venue, watching video clips. These types of features may facilitate a user experience in venues such as museums, art exhibits, natural landmarks—e.g., caverns, caves, to name a few.

In some embodiments, the system 100 further includes an administration device 106. The administration device 106 is configured to detect the signal transmission device 102, delete the signal transmission device 102, and define a photography prohibited zone. In particular, the administration device 106 may be any computing device, including a processor 106A and a memory 106B, for use by a person responsible for a place having areas that require privacy or an administrator of the system 100. The memory 106B is configured to store program instructions, which when executed by the processor 106A, implements an administration software. In one implementation, the administration software included in the administration device 106 is configured to activate the signal transmission devices 102. Further, the administration device 106 is configured to specify day, time, and period in which the private zone is considered active. In other words, administration device 106 may provide computational capabilities to the signal transmission devices 102, in order for them to work properly and in accordance with a set of instructions, that are implemented by the administration device 106 including the day, time, and period in which the private zone is to be considered a no camera zone. Further, in one implementation, the administration software may provide a registration facility for a responsible person, signal transmission device activation facility, and further ensure eligibility and authenticity of various components present in the system 100. As such, the administration device 106 is configured to search for a signal of a new signal transmission device 102 that is relevant only to the system 100, detect a signal and verify reliability of the new signal transmission device 102 through a verification mechanism. In general, verification mechanism may rely on any suitable authentication system. Further, the administration device 106 is configured to add the new signal transmission device 102, post verification, within a range of the administration device 106 so that the new signal transmission device 102 begins to transmit a signal. The new signal transmission device 102 added in the system 100 is authenticated using the above-described technique. In some examples, there may be more than one signal transmission devices 102 that are to be added to the system 100, based on an area of employment of the system 100. In addition, the administration device 106 is configured to monitor the signal transmission devices 102, including detecting activity level, and battery level. As described above, the signal transmission devices 102 are BLE enabled devices drawing operational current from the battery 102B. In order to keep the signal transmission devices 102 working at optimal capacity, the administration device 106 monitors the battery level of the battery 102B and alerts a responsible person or an administrator of the system 100 if the battery levels fall below a preset limit. Furthermore, the detecting activity levels are also constantly monitored in order to keep the transmission devices 102 working at optimal capacity.

In some examples, the system 100 may be employed in such a way that the system 100 covers several private zones. As such, the system 100 monitors multiple private zones in order to maintain optimal efficacy in restricting camera use of smart devices 104 in the multiple private zones. In one implementation, the administration device 106 is further configured to monitor status of the signal transmission devices 102 and switching the signal transmission devices 102 to new private zones. The signal transmission devices 102 may be configured to restrict camera use in multiple private zones at the same time. Switching to new private zones can be decided by the administration device 106 based on an administrator input.

Furthermore, to practically enable switching to new private zones, different subsets of signal transmission devices 102 may be activated and deactivated. As such, the administration device 106 is configured to turn on and off, subsets of the plurality of signal transmission devices 102 for different private zones. In an example, a first subset of the signal transmission devices 102 may enforce the private zone in a first area and a second subset of the signal transmission devices 102 may enforce the private zone in a second area.

To further enhance the aforementioned process, the system 100 provides time period based scheduling of private zones. As such, the administration device 106 is further configured to turn on and off, the subsets of the signal transmission devices 102 according to a schedule of time periods. In an example, if a private zone is to be enforced in a private corporate building, the administration device 106 can configure the subset of signal transmission devices 102 to be turned on during working hours and turned off during nighttime.

Moreover, the system 100 includes a backend server 108. In general, backend server refers to computational hardware that receives and sends out files and data requests pertaining to a particular program application. In some embodiments, the signal transmission devices 102 are configured to interact with the backend server 108. Further, the backend server 108 is configured to authenticate the administration device 106 and the signal transmission devices 102. The backend server 108 includes large scale hardware components, providing the system 100 with major computational capacity and hence the backend server 108 is configured to manage operation of the system 100 in order to provide uninterrupted services in the area of employment of the system 100. In addition, the backend server 108 is configured to save and analyze system data associated with the system 100 and control system security of the system 100. In other words, the backend server 108 prevents unauthorized access to the system 100 and prevents unauthorized operational use of the system 100 to maintain security for a number of individuals associated with the system 100.

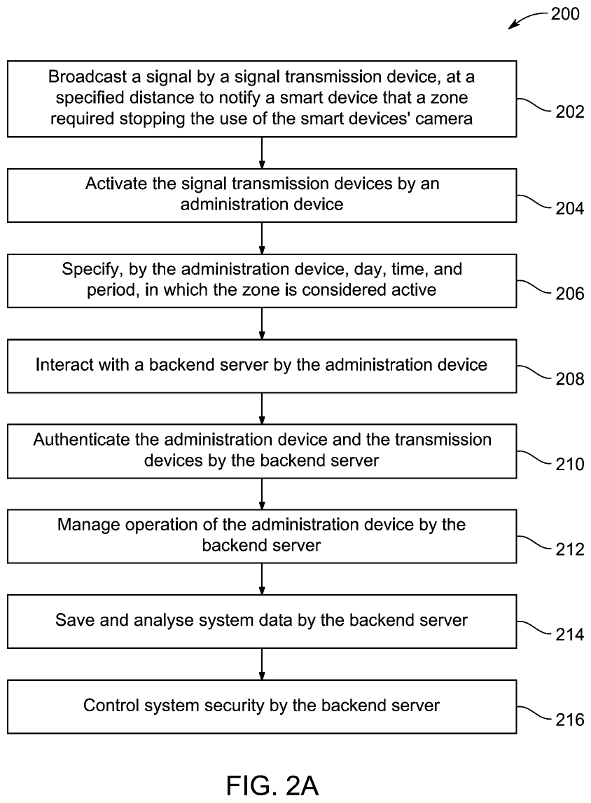

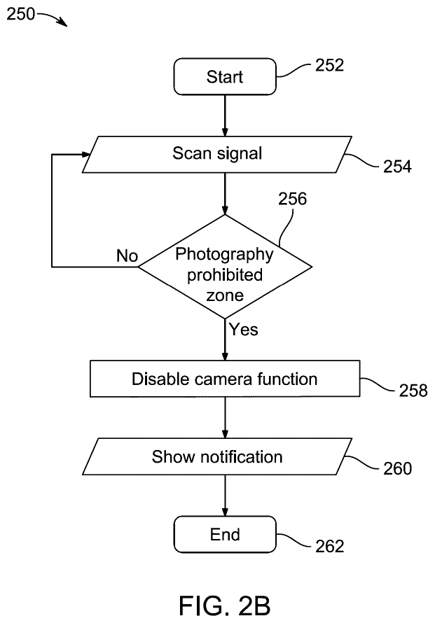

Referring to FIG. 2A, a flow diagram of a method 200 for restricting camera use is illustrated, according to certain embodiments. The order in which the method 200 is described is not intended to be construed as a limitation, and any number of the described method steps can be combined in any order to implement the method 200. Additionally, individual steps may be removed or skipped from the method 200 without departing from the spirit and scope of the present disclosure.

At step 202, the method 200 includes broadcasting, by the signal transmission device 102, the signal at a specified distance to notify the smart device 104 that a zone requires stopping the use of the camera of the smart devices 104. The signal transmission device 102 is powered for a maximum range that ensures the signal is sustainable for a required distance for a required period of time. One approach increases power and power duration to the device by plugging it into an external power source to supplement the upper limit of the internal battery, given its limited power. The responsible person can also add several signal transmission devices at different distances, where each device covers its own signal range, thus covering the entire private area while conserving energy consumption.

In particular the method 200 includes, broadcasting, by the signal transmission device 102, the signal as a low energy signal. In other words, the broadcasting includes sending out a particular signal form the signal transmission device 102 that is readable by a signal receiver of the smart device 104. The smart device 104 then processes the broadcast signal and instructs a processor of the smart device 104 to disable the camera function.

At step 204, the method 200 includes activating, by the administration device 106, the signal transmission devices 102. As described above, the administration device 106 authenticates and activates signal transmission devices 102 based on a request by the administrator of the system 100.

At step 206, the method 200 includes specifying, by the administration device 106, day, time, and period in which a private zone of a specified boundary is considered active. In an example, if the system 100 is employed in an exclusive art museum to restrict visitors from capturing photographs and videos of the art displayed in the museum, then the system 100 may have similar operational hours as the museum. In such a case, the administration device 106 may be used to specify a time of switching the system 100 ‘on’ and ‘off’. Further, as described at step 206, the administration device 106 may specify the operational time period of the system 100 to be similar to the operational time period of the art museum. In some embodiments, the same methodology may be applied in any use case of the system 100.

At step 208, the method 200 includes interacting, by the administration device 106, with the backend server 108. In order for the system 100 to perform as intended, the administration device 106 needs to be in constant communication with the backend server 108 at least during periods when private zones are enforced and are being monitored. The backend server 108 and the administration device 106 may exchange data analytics and information on the number of users present in the system 100 and the signal transmission devices 102. The administration device 106 stores all information associated with the signal transmission devices 102, in the backend server 108.

At step 210, the method 200 includes authenticating, by the backend server 108, the administration device 106 and the signal transmission devices 102. In some aspects, the system 100 is a secure closed-loop system with a certain level of encryption. This is to maintain safety and security of the data associated with signal transmission devices 102 and the smart devices 104 of the user, and to differentiate between genuine requests and counterfeit requests. Hence, the system 100 authenticates the administration device 106 and the signal transmission devices 102 with the backend server 108.

At step 212, the method 200 includes managing, by the backend server 108, operation of the administration device 106. As described above with respect to the system 100, the administration device 106 executes a plurality of functions in the system 100 such as, authenticating components, adding and deleting signal transmission devices 102, adding and deleting administrators and other responsible users. In order to perform such functions, the administration device 106 requires additional processing capacity and memory, which are in-turn provided by the backend server 108, therefore, backend server 108 manages a plurality of operations associated with the administration device 106.

At step 214, the method 200 includes saving and analyzing system data, by the backend server 108. In particular, the system 100 includes several various data sets. The data sets may include data associated with the signal transmission devices 102, the smart device 104, the administration software, and several other operationally vital data. However, the signal transmission devices 102 and the administration device 106 may be compact in nature, hence may possess limited computational abilities. Therefore, the backend server 108 performs saving and analyzing operations on the system data, associated with the system 100.

At step 216, the method 200 includes controlling system security by the backend server 108. In some aspects, the system 100 for restricting camera use in a private zone is a closed loop encrypted system. In other words, the components included in the system 100 are authenticated and secure, in order to prevent privacy of individuals associated with the system 100 and further prevent any kind of data breach. Hence, to implement end-to-end system security, the backend server 108 includes a plurality of system security protocols, in place to perform regular safety checks on the system 100 and maintain privacy. In addition, the method 200 may perform a number of additional processes based on a request generated by the backend server 108 on a command of the administrator of the system 100.

In some embodiments, the method 200 further includes defining, by the administration device 106, a photography prohibited zone. In other words, the administration device 106 defines the photography prohibited zone in which the camera of the smart devices 104 are to be disabled. Further, the aforementioned zone and the confines of it may be modified as per addition or deletion of new and obsolete signal transmission devices 102, respectively.

Referring to FIG. 2B, a flowchart of a method 250 depicting interaction of the system 100 with the client smart device 104 is illustrated, according to certain embodiments. The order in which the method 250 is described is not intended to be construed as a limitation, and any number of the described method steps can be combined in any order to implement the method 250. Additionally, individual steps may be removed or skipped from the method 250 without departing from the spirit and scope of the present disclosure.

At step 252, the method 250 includes starting of an interaction process between the client smart device 104 and the system 100 for disabling camera function in the client smart device 104.

At step 254, the method 250 includes interacting between the client smart device 104 with the signal transmission device 102, including scanning for a signal from the signal transmission device 102. At step 256 and 258, when a scan signal is detected indicating a zone where photography is prohibited, the method 250 includes disabling, by the administration device 106, a camera function in the client smart device 104. As described with respect to FIG. 2A, the camera function of the client smart device 104 is disabled with assistance from the administration software, when the client smart device 104 enters the photography prohibited zone. However, the system 100 may restart the camera function as soon as the client smart device 104 exits the photography prohibited zone, hence, when the scan signal indicates that the client smart device 104 is exiting the photography prohibited zone, the camera function can be reactivated.

At step 260, in the case when the client smart device 104 is entering the photography prohibited zone, the method 250 includes displaying, in the administration device 106, notification that the camera function of a particular client smart device 104 has been disabled and when the client smart device 104 is exiting the photography prohibited zone, display a notification that the camera function has been reactivated. Furthermore, at step 262, the method 250 ends after execution of the program instruction.

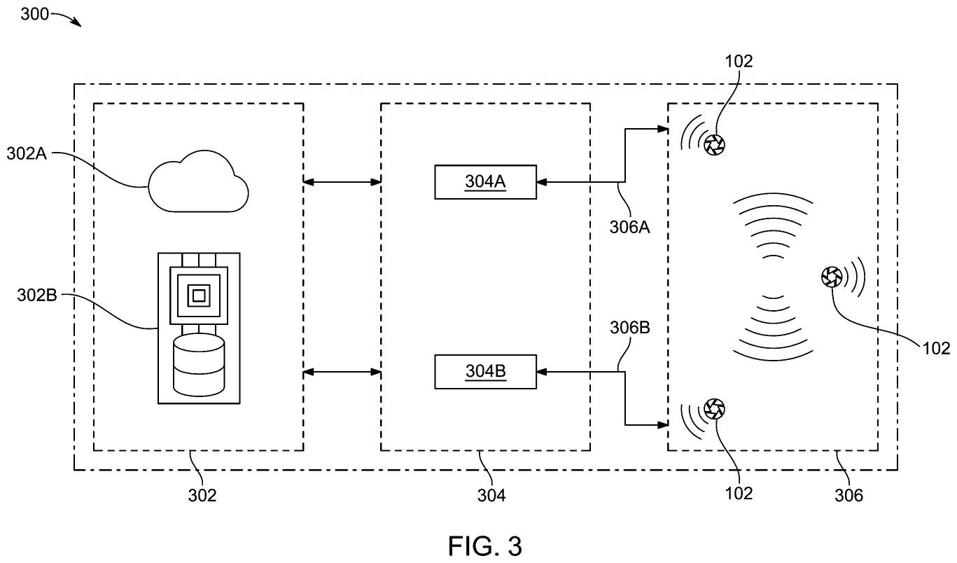

Referring to FIG. 3, a schematic block diagram depicting an exemplary architecture 300 of the system 100 is illustrated, according to certain embodiments. In particular, the exemplary architecture 300 includes a backend service 302, a frontend application 304, and a private zone 306, in which photography is not allowed, alternatively referred to as the No Camera zone 306. In one implementation, the backend service 302 includes a cloud service 302A and an in-premise service 302B for the system 100. The cloud service 302A is responsible for operational information and data storage, while the in-premise service 302B refers to the backend server 108 and associated features and functionalities of the backend server 108. Further, the frontend application 304 includes a mobile computing software 304A installed on a smart device of the owner or system administrator and a client-side mobile computing software 304B installed on the plurality of smart devices 104. In particular, in order for the system 100 to work, the mobile computing software 304A including data and applications related to the system 100 is installed on the smart device 104 of the owner, who implements a private zone and defines an area to be covered under the private zone. Similarly, for the system 100 to work as intended, the client-side mobile computing software 304B is developed and installed on the plurality of smart devices 104 corresponding to a plurality of users present in the area covered under the private zone as implemented by the owner. Furthermore, the system 100 includes the private zone 306, which is implemented in the area where the system 100 is installed with the signal transmission devices 102. In particular, the private zone 306 includes at least two signal transmissions, a connection signal 306A for the owner or the administrator of the system 100 and a broadcast signal 306B transmitted by the signal transmission devices 102 for the restriction of the camera function of the smart devices 104.

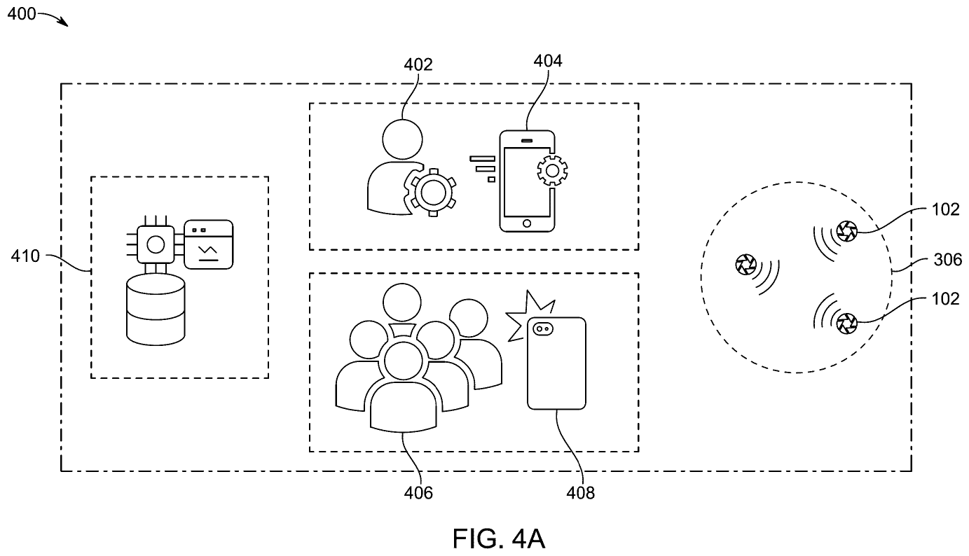

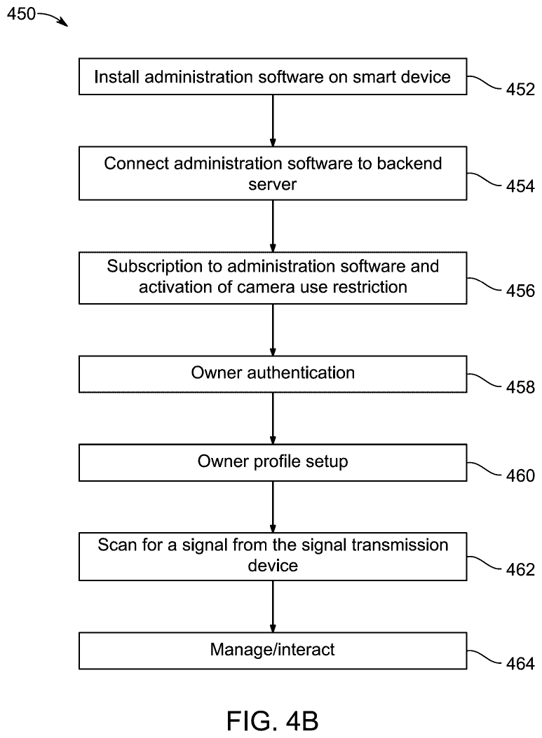

Referring to FIG. 4A, a schematic block diagram of a system architecture 400 for client and enterprise use is illustrated, according to certain embodiments. In particular, FIG. 4A shows the system architecture 400 for the system 100 if used at client end and owner end. In one embodiment, the system architecture 400 may be implemented for enterprise or organizational use. In another embodiment, the system architecture 400 may be implemented for individual use. Enterprise use refers to implementation of the system 100 by large organizations and large areas whereas individual refers to the implementation of the system 100 in a relatively small place. In addition, the system 100 and associated with individual use may host services on an in-premise server rather than a cloud computing architecture. In some embodiments, the system architecture 400 includes a responsible person 402 having a an administration application 404. The administration application 404 can be the same administration software that is associated with the administration device 106. Further, the responsible person 402 may be anyone with administrative access to the system 100. Further, the system architecture 400 includes an end user 406 and a client smart device 408. A person with ordinary skill in the art would understand that there may be more than one end user 406 and collectively can be referred to as the ‘end users 406’ and there may be more than one client smart device 408 and collectively can be referred to as ‘user devices 408’. The user devices 408 may include any smart device such as, but are not limited to, android smartphones, iOS smartphones, smartwatches, and cameras. Furthermore, the system architecture 400 includes the signal transmission devices 102 and an in-premise server 410. The in-premise server 410 includes program instructions and data related to the user devices 408, the owner 402, and the signal transmission devices 102. In some embodiments, the system architecture 400 can include connection to cloud enabled service of the system 100 in case of enterprise use.

FIG. 4B is a flowchart of a method 450 of installation of the administration software on the administration device 106, according to certain aspects. The order in which the method 450 is described is not intended to be construed as a limitation, and any number of the described method steps can be combined in any order to implement the method 450. Additionally, individual steps may be removed or skipped from the method 450 without departing from the spirit and scope of the present disclosure.

At step 452, the method 450 includes installing the administration software on the administration device 106. The administration device 106 may include a smartphone, a computer, a portable computing device, or a tablet computer. As described above, the administration software includes a set of program instructions to implement the system 100 for restricting camera use.

At step 454, the method 450 includes connecting the administration software installed on the administration device 106 to the backend server 108 via cloud computing in case of enterprise use. In some examples, for individual use cases, the administration device 106 is configured to virtually connect with in-premise service, present at the site of employment of the system 100.

At step 456, the method 450 includes subscribing to administration software and activating the restriction of the camera function. Further, at step 458, the method 450 includes responsible person authentication. In other words, for every new responsible person 402, the system 100 runs an authentication verification service in order to maintain privacy and security of the system 100. This ensures that the responsible person 402 is subscribed for genuine administration software and has rights to use the administration software.

At step 460, the method 450 includes setting up a profile for the responsible person 402. In one implementation, the administration software and the system 100 allows for multiple person profiles to be set up from a single person smart device. This allows for multiple administrators to ensure restriction of camera use in the private zone throughout a day. Each responsible person 402 may have their own profiles with their own preferences and shortcut setup for quick and easy access to the system 100.

At step 462, the method 450 includes scanning for the signal from at least one of a signal transmission device 102, and subsequently at step 464, the method 450 includes interacting with the signal transmission device 102 for implementing the restriction of camera use by the system 100.

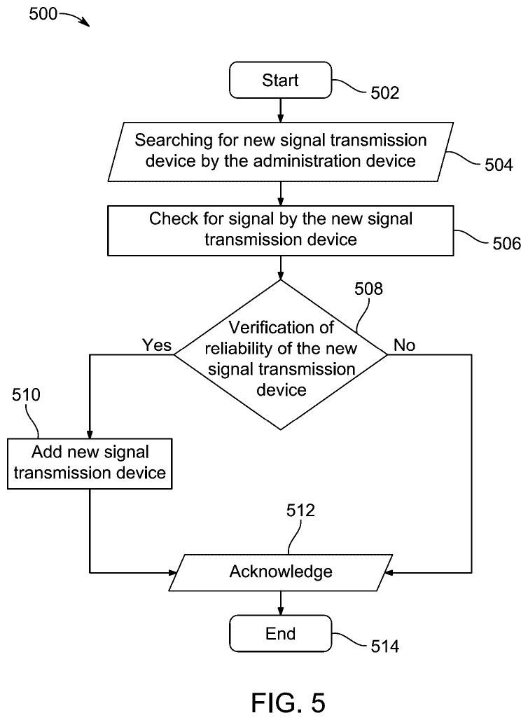

Referring to FIG. 5, a flow diagram of a method 500 for adding signal transmission devices 102 to the system 100 is illustrated, according to certain aspects. The order in which the method 500 is described is not intended to be construed as a limitation, and any number of the described method steps can be combined in any order to implement the method 500. Additionally, individual steps may be removed or skipped from the method 500 without departing from the spirit and scope of the present disclosure.

At step 502, the method 500 includes starting the process of adding new signal transmission device 102 via administration software included in the administration device 106. Further, at step 504, the method 500 includes searching, by the administration device 106, for a signal of the new signal transmission device 102 that is relevant only to the system 100. In an example, the signal transmission device 102 is activated and mounted at a place hidden from view and in the vicinity of the administration device 106. Further, the administration software included in the administration device 106 may be activated by the responsible user 402 in order to search for the new signal transmission devices 102. In particular, the administration software searches for the signal of new signal transmission devices 102 and that are relevant only to the system 100, excluding signals that do not belong to the system 100.

At step 506, the method 500 checks if there is a signal by the new signal transmission device 102 and further connects to the new transmission device 102.

At step 508, the method 500 includes verifying, by the administration device 106, reliability of the new signal transmission device 102 through verification mechanisms. The verification mechanisms used herein are advanced software solutions used in the field of peripheral validation. The verification mechanisms may reduce safety and privacy breaches of the system 100.

At step 510, the method 500 includes adding, by the administration device 106, the new signal transmission device 102 so that the signal transmission device 102 begins to operate as intended. At step 512, the method 500 sends out an acknowledgement that the new transmission device 102 has been added to the system 100 in case of successful connection. However, step 512 is also executed when the connection or authentication fails and the new transmission device 102 is not added to the system 100, letting the owner 402 know about the possible failed connection.

At step 512, the method 500 includes terminating the new transmission device addition process.

The system 100 is further equipped to delete existing signal transmission devices 102 in case they are no longer required. In particular, deleting, by the administration device 106, the signal transmission devices 102. The administration software included in the administration device 106 may delete any obsolete signal transmission devices 102 at a discretion of the responsible person 402.

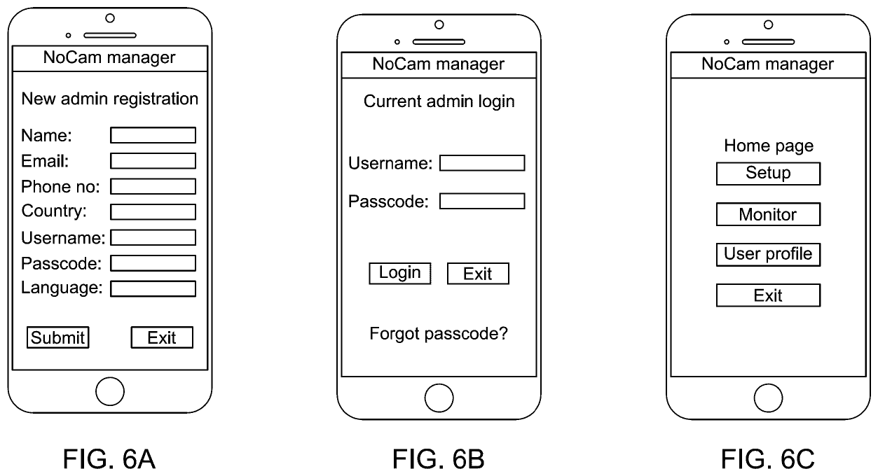

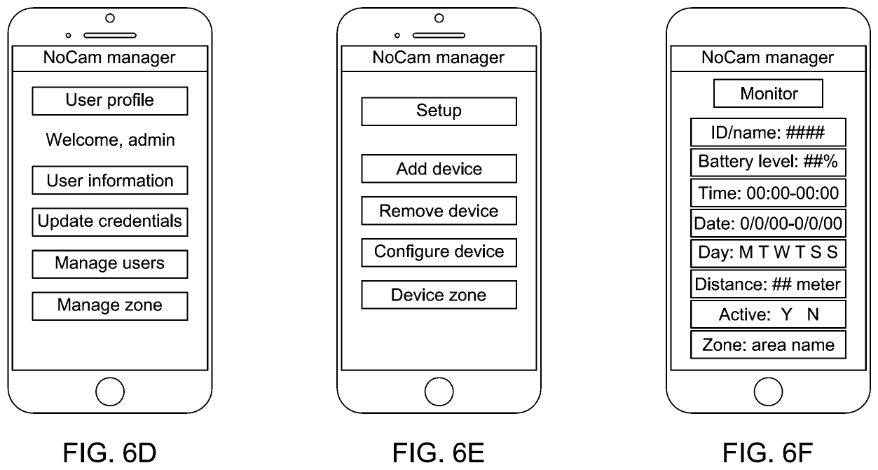

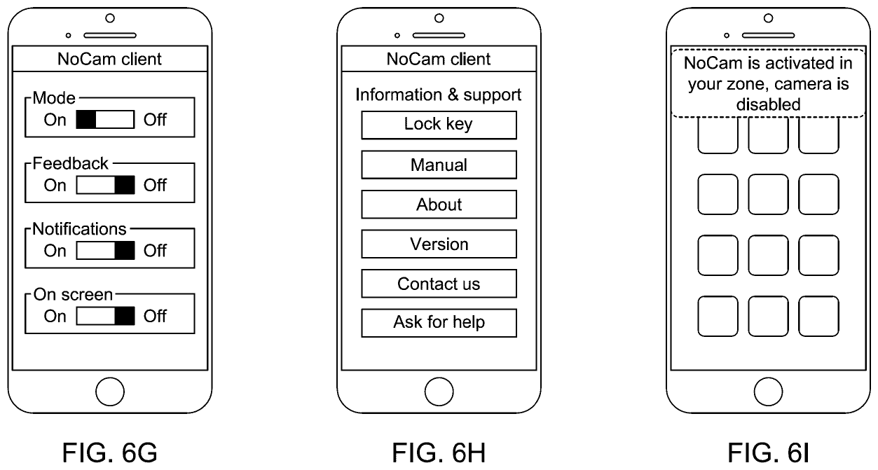

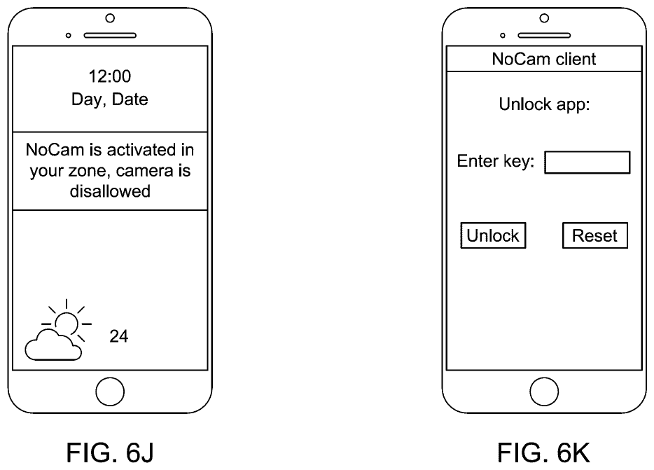

Referring to FIGS. 6A-6F, an exemplary user interface of the administration software is illustrated, according to certain embodiments. In particular, FIGS. 6A-6F show the exemplary user interface that the responsible person 402 may interact with. The responsible person interacts with the system through several displays, including but not limited to sign up, login, device management, monitoring, user management. However, a person with ordinary skill in the art would appreciate that user interface depicted in FIGS. 6A-6F is only exemplary and that any other user interface may be used or provided, while maintaining the functionality of the system 100 remain same.

Referring to FIG. 6A, the user interface displays new responsible person registration screen for administrative use. From this screen, the responsible person 402 may register to avail the services provided by the system 100.

Referring to FIG. 6B, the user interface displays a login screen for the responsible person 402. After registration on the first screen, the responsible person 402 may log-in and log-out depending upon a use case from the aforementioned screen.

Further, referring to FIG. 6C, the user interface displays a main admin screen. In particular, the main admin screen shows several options including, but not limited to, device settings, monitoring setting, control settings, and exit.

Referring to FIG. 6D, the user interface displays an account screen, where the responsible person 402 may alter several aspects of the administration software such as, account information, personal information, login credentials, user information, system updates, zone management, user management, and the like.

Further, referring to FIG. 6E, the user interface displays control screen for the signal transmission devices 102. In particular, the responsible person 402 may control several aspects related to the signal transmission devices 102 from this screen, such as, adding, removing, configuring, locating, and adjusting signal transmission devices 102. Once a signal transmission device is powered on, it can be added as a device that can accept command signals from the administration application 404. The responsible person 402 may delete a signal transmission device 102, such that the signal transmission device 102 will stop sending out control signals. The responsible person 402 can configure a signal transmission device 102 to transmit control signals at a certain power in order to define a distance that the signal transmission device 102 covers. The responsible person 402 can configure a photography prohibited zone by designating particular signal transmission devices 102 as being assigned to a named zone.

Referring to FIG. 6F, the user interface displays technical screen, herein, the responsible person 402 may monitor a plurality of technical aspects of the signal transmission devices 102. The technical aspects include ID/name, battery level, distance, activity, zone, time, day, and date, associated with the signal transmission devices 102. The responsible person 402 can quickly view the status of a signal transmission device 102, to check whether it is active, or not, its distance setting, the zone that it is assigned to, a day(s) and time that the signal transmission device is scheduled to operate.

Referring to FIGS. 6G-6K, an exemplary client user interface of the client smart device 408 software is illustrated, according to certain embodiments. The end user (client) interfaces are simpler and have less authority compared to the admin interfaces. The purpose of the client user interfaces is to interact with hardware signals that indicate where to block the use of the camera via the client smart device 408. The functions provided by the client user interface include, but are not limited to, the following: activating the system, setting an application lock, setting system notifications and other messages.

Further, referring to FIG. 6G, the user interface for a client smart device 408 displays service screen for the client user 406. In particular, the client user 406 may control initial activation of the photography disabling service, related notifications, and appearance of the user interface on the screen. Activation of the photography disabling service authorizes the service to access the camera function of the client smart device 408.

Referring to FIG. 6H, the user interface for the client smart device 408 displays control and support screen for the client user 406. Herein, the client user 406 may access a user manual that explains how to use the system 100, software version information, contact information for further information about the photography disabling service 402 and a support team for the system 100 and further ask for support from the support team. The client user 406 may also enquire about the safety and security parameters of the system 100 from this screen.

Furthermore, referring to FIG. 6I, the user interface for the client smart device 408 displays an exemplary notification screen, in case the end user 406 enters the private zone 306. The notification screen assists the system 100 in informing the end user 406 that their camera function has been disabled due to their entry in the private zone 306. This allows for greater transparency between the end user 406 and the responsible person 402.

Moreover, referring to FIG. 6J, the user interface for the client smart device 408 displays another way of notifying the end user 406 regarding restriction of camera use when the client smart device 104 of the end user 406 is locked. Again, the notification screen assists the system 100 in informing the end user 406 that their camera function has been disabled due to their entry in the private zone 306.

In addition, referring to FIG. 6K, the user interface for the client smart device 408 displays a lock screen, where the end user 406 may enter a security key to access the system 100 when sharing the client smart device 104. The system protects the client application with an access key when needed to prevent others from altering the settings, especially when smart device sharing has been allowed.

In summary, aspects of the present disclosure describe the system 100 for restricting camera use and the method 200 thereof. The system 100 is designed to have minimal maintenance and installation costs. Further, the system 100 may be employed as a retrofit option at a particular area of installation. Furthermore, the system 100 may be used in an area with high privacy concerns such as, museums, intellectual property conventions, government buildings, schools, educational institutions, military establishments, judicial establishments, private hotel rooms, hospitals, financial institutions, and public places with sensitive information on display. In addition, the system 100 includes economically feasible components, which are readily available all over the world, enabling in handy installation of the system 100. The system 100 is hosted on backend server 108 and, in some cases, on in-premise servers, which makes the system 100 a reliable and secure system, with ease of remote access. Moreover, the system 100 is configured to be highly energy efficient, as it uses BLE technology and is hosted on servers and smartphones.

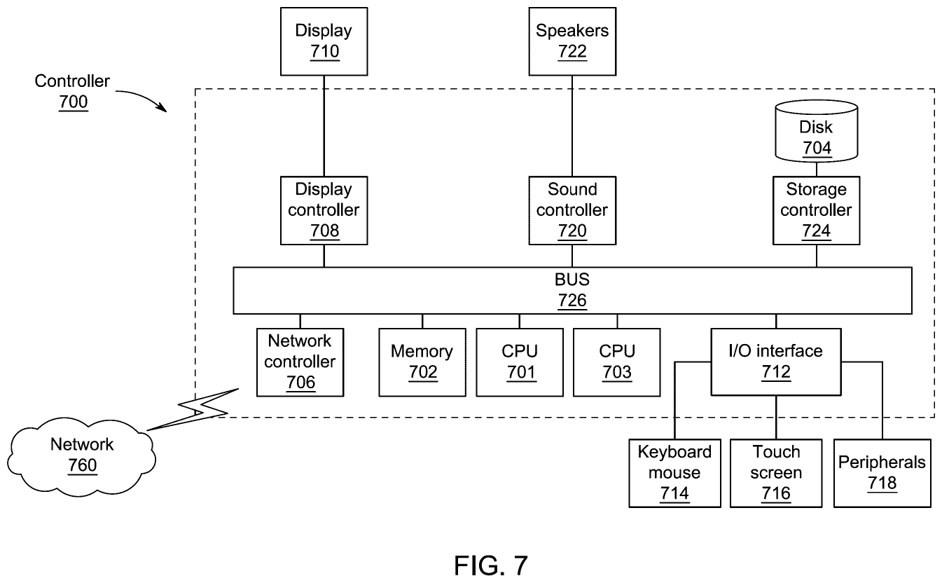

Next, further details of the hardware description of the computing environments described in the system 100, exemplary architecture 300, and system architecture 400, according to exemplary aspects is described with reference to FIG. 7. In FIG. 7, a controller 700 is described is representative of the system 100 of FIG. 1, in which the controller is a computing device which includes a CPU 701 which performs the processes described above/below. The process data and instructions may be stored in memory 702. These processes and instructions may also be stored on a storage medium disk 704 such as a hard drive (HDD) or portable storage medium or may be stored remotely.

Further, the present disclosure is not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the present disclosure may be provided as a utility application, background daemon, or component of an operating system, or combination thereof, executing in conjunction with CPU 701, 703 and an operating system such as Microsoft Windows 10 or later, UNIX, LINUX, Apple MAC-OS and other systems known to those skilled in the art.

The hardware elements in order to achieve the computing device may be realized by various circuitry elements, known to those skilled in the art. For example, CPU 701 or CPU 703 may be a Xenon or Core processor from Intel of America or an Opteron processor from AMD of America, or may be other processor types that would be recognized by one of ordinary skill in the art. Alternatively, the CPU 701, 703 may be implemented on an FPGA, ASIC, PLD or using discrete logic circuits, as one of ordinary skill in the art would recognize. Further, CPU 701, 703 may be implemented as multiple processors cooperatively working in parallel to perform the instructions of the inventive processes described above.

The computing device in FIG. 7 also includes a network controller 706, such as an Intel Ethernet PRO network interface card from Intel Corporation of America, for interfacing with network 760. As can be appreciated, the network 760 can be a public network, such as the Internet, or a private network such as an LAN or WAN network, or any combination thereof and can also include PSTN or ISDN sub-networks. The network 760 can also be wired, such as an Ethernet network, or can be wireless such as a cellular network including EDGE, 3G, 4G and 5G wireless cellular systems. The wireless network can also be Wi-Fi, Bluetooth, or any other wireless form of communication that is known.

The computing device further includes a display controller 708, such as a NVIDIA GeForce GTX or Quadro graphics adaptor from NVIDIA Corporation of America for interfacing with display 710, such as a Hewlett Packard HPL2445w LCD monitor. A general purpose I/O interface 712 interfaces with a keyboard and/or mouse 714 as well as a touch screen panel 716 on or separate from display 710. General purpose I/O interface also connects to a variety of peripherals 718 including printers and scanners, such as an OfficeJet or DeskJet from Hewlett Packard.

A sound controller 720 is also provided in the computing device such as Sound Blaster X-Fi Titanium from Creative, to interface with speakers/microphone 722 thereby providing sounds and/or music.

The general purpose storage controller 724 connects the storage medium disk 704 with communication bus 726, which may be an ISA, EISA, VESA, PCI, or similar, for interconnecting all of the components of the computing device. A description of the general features and functionality of the display 710, keyboard and/or mouse 714, as well as the display controller 708, storage controller 724, network controller 706, sound controller 720, and general purpose I/O interface 712 is omitted herein for brevity as these features are known.

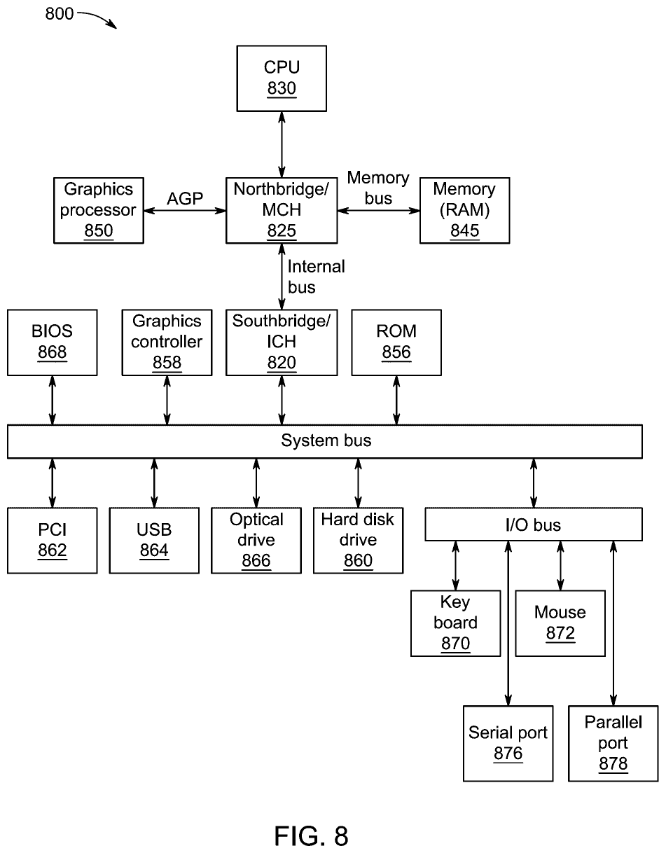

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 8.

FIG. 8 shows a schematic diagram of a data processing system, according to certain embodiments, for performing the functions of the exemplary embodiments. The data processing system is an example of a computer in which code or instructions implementing the processes of the illustrative embodiments may be located.

In FIG. 8, data processing system 800 employs a hub architecture including a north bridge and memory controller hub (NB/MCH) 825 and a south bridge and input/output (I/O) controller hub (SB/ICH) 820. The central processing unit (CPU) 830 is connected to NB/MCH 825. The NB/MCH 825 also connects to the memory 845 via a memory bus and connects to the graphics processor 850 via an accelerated graphics port (AGP). The NB/MCH 825 also connects to the SB/ICH 820 via an internal bus (e.g., a unified media interface or a direct media interface). The CPU Processing unit 830 may contain one or more processors and even may be implemented using one or more heterogeneous processor systems.

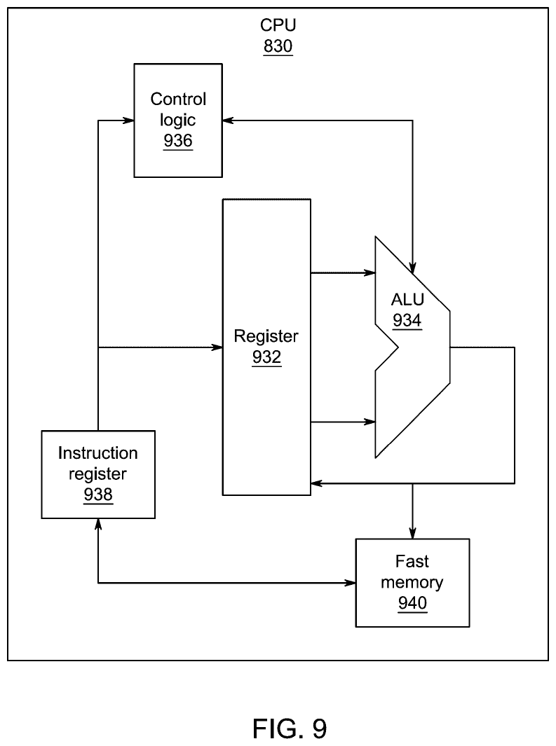

For example, FIG. 9 shows one implementation of CPU 830. In one implementation, the instruction register 938 retrieves instructions from the fast memory 940. At least part of these instructions is fetched from the instruction register 938 by the control logic 936 and interpreted according to the instruction set architecture of the CPU 830. Part of the instructions can also be directed to the register 932. In one implementation the instructions are decoded according to a hardwired method, and in another implementation the instructions are decoded according to a microprogram that translates instructions into sets of CPU configuration signals that are applied sequentially over multiple clock pulses. After fetching and decoding the instructions, the instructions are executed using the arithmetic logic unit (ALU) 934 that loads values from the register 932 and performs logical and mathematical operations on the loaded values according to the instructions. The results from these operations can be feedback into the register and/or stored in the fast memory 940. According to certain implementations, the instruction set architecture of the CPU 830 can use a reduced instruction set architecture, a complex instruction set architecture, a vector processor architecture, a very large instruction word architecture. Furthermore, the CPU 830 can be based on the Von Neuman model or the Harvard model. The CPU 830 can be a digital signal processor, an FPGA, an ASIC, a PLA, a PLD, or a CPLD. Further, the CPU 830 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 8, the data processing system 800 can include that the SB/ICH 820 is coupled through a system bus to an I/O Bus, a read only memory (ROM) 856, universal serial bus (USB) port 864, a flash binary input/output system (BIOS) 868, and a graphics controller 858. PCI/PCIe devices can also be coupled to SB/ICH 888 through a PCI bus 862.

The PCI devices may include, for example, Ethernet adapters, add-in cards, and PC cards for notebook computers. The Hard disk drive 860 and CD-ROM 866 can use, for example, an integrated drive electronics (IDE) or serial advanced technology attachment (SATA) interface. In one implementation the I/O bus can include a super I/O (SIO) device.

Further, the hard disk drive (HDD) 860 and optical drive 866 can also be coupled to the SB/ICH 820 through a system bus. In one implementation, a keyboard 870, a mouse 872, a parallel port 878, and a serial port 876 can be connected to the system bus through the I/O bus. Other peripherals and devices that can be connected to the SB/ICH 820 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry or based on the requirements of the intended back-up load to be powered.

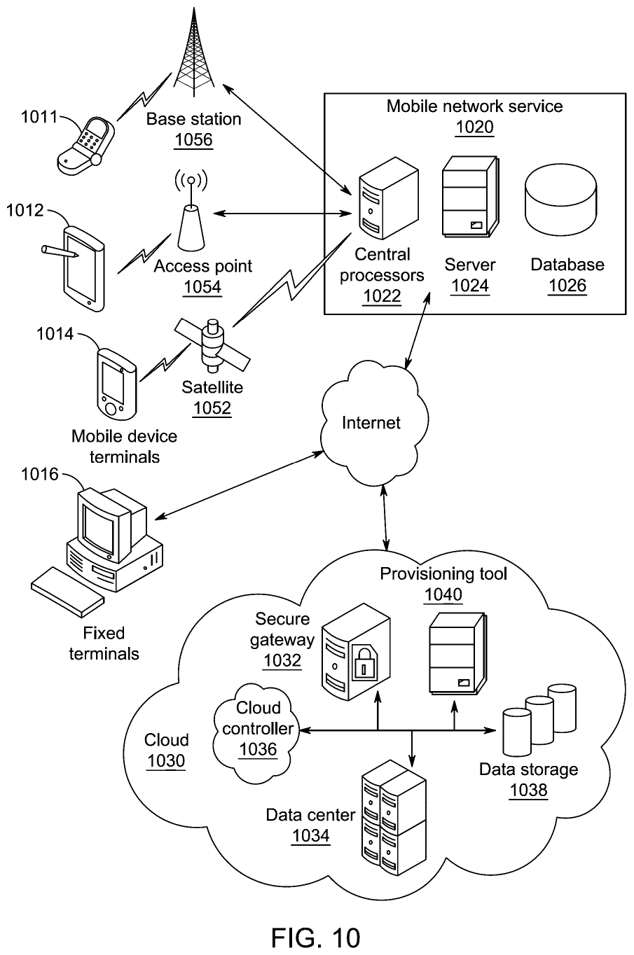

The functions and features described herein may also be executed by various distributed components of a system. For example, one or more processors may execute these system functions, wherein the processors are distributed across multiple components communicating in a network. The distributed components may include one or more client and server machines, such as cloud 1030 including a cloud controller 1036, a secure gateway 1032, a data center 1034, data storage 1038 and a provisioning tool 1040, and mobile network services 1020 including central processors 1022, a server 1024 and a database 1026, which may share processing, as shown by FIG. 10, in addition to various human interface and communication devices (e.g., display monitors 1016, smart phones 1010, tablets 1012, personal digital assistants (PDAs) 1014). The network may be a private network, such as a LAN, satellite 1052 or WAN 1054, or be a public network, may such as the Internet. Input to the system may be received via direct user input and received remotely either in real-time or as a batch process. Additionally, some implementations may be performed on modules or hardware not identical to those described. Accordingly, other implementations are possible.

The above-described hardware description is a non-limiting example of corresponding structure for performing the functionality described herein.

Numerous modifications and variations of the present disclosure are possible in light of the above teachings. It is therefore to be understood that the invention may be practiced otherwise than as specifically described herein.

1. A system for restricting camera use in a photography prohibited zone, comprising:
a plurality of signal transmission devices configured to
broadcast a control signal at a specified distance to notify a client smart device that the client smart device has entered the photography prohibited zone, wherein the control signal requires turning off of camera function on the client smart device;
an administration device configured to
activate the plurality of signal transmission devices to broadcast the control signal,
set the specified distance that each of the plurality of signal transmission devices broadcasts the control signal in order to define a boundary of the photography prohibited zone,
set day, time, and period in which the photography prohibited zone is considered active, and
interact with a backend server; and
wherein the backend server is configured to
authenticate the administration device and the plurality of signal transmission devices,
manage operation of the administration device,
save and analyze system data, and
control system security.

2. The system of claim 1, wherein the administration device is configured to
transmit a search signal for a relevant signal transmission device that is relevant only to the system,
detect a response signal to the search signal and verify reliability of the relevant signal transmission device through a verification mechanism, and
add the relevant signal transmission device within a range of the administration device so that the relevant signal transmission device begins to receive command signals from the administration device.

3. The system of claim 1, wherein the administration device is configured to
delete one signal transmission device among the plurality of signal transmission devices such that the one signal transmission device stops broadcasting control signals.

4. The system of claim 1, wherein the administration device is configured to
monitor the plurality of signal transmission devices, including detecting their activity level, and battery level.

5. The system of claim 1, further comprising:
the client smart device, including
scan for the control signal from the signal transmission device,
when the control signal is detected indicating the photography prohibited zone, disable the camera function on the client smart device,
display a notification that the camera function has been disabled, and
when the control signal indicates that the client smart device is exiting the photography prohibited zone, reactivate the camera function and display a notification that the camera function has been reactivated.

6. The system of claim 1, wherein at least one of the plurality of signal transmission devices is mounted such that it is hidden from view by a user of the client smart device.

7. The system of claim 1, wherein the plurality of signal transmission devices is configured to
broadcast a low energy control signal including a notification to alert a pedestrian user of the client smart device that a private zone has been entered where camera usage is prohibited.

8. The system of claim 1, wherein the administration device is further configured to monitor status of the plurality of signal transmission devices to include transmission of a switching command signal for switching to different photography prohibited zones.

9. The system of claim 1, wherein the administration device is further configured to transmit a power command signal to turn on and off subsets of the plurality of signal transmission devices for different photography prohibited zones.

10. The system of claim 9, wherein the administration device is further configured to transmit a scheduling command signal to turn on and off the subsets of the plurality of signal transmission devices according to a schedule of time periods.

11. A method of restricting camera use in a photography prohibited zone, comprising:
broadcasting, by at least one signal transmission device, a control signal at a specified distance to notify a client smart device that the client smart device has entered the photography prohibited zone, wherein the control signal that requires turning off of camera function on the smart client device;
activating, by an administration device, the at least one signal transmission device to broadcast the control signal;
setting, by the administration device, the specified distance that the at least one signal transmission device broadcasts the control signal in order to define a boundary of the photography prohibited zone;
setting, by the administration device, day, time, and period in which the photography prohibited zone is considered active;
interacting, by the administration device, with a backend server;
authenticating, by the backend server, the administration device and the at least one signal transmission device;
managing, by a backend server, operation of the administration device;
saving and analyzing system data, by the backend server; and
controlling, by the backend server, system security.

12. The method of claim 11, further comprising:
transmitting, by the administration device, a search signal for a relevant signal transmission device that is relevant only to the photography prohibited zone;
when a response signal is detected, verifying, by the administration device, reliability of the relevant signal transmission device through a verification mechanism; and
adding, by the administration device, the relevant signal transmission device within a range of the administration device so that the relevant signal transmission device begins to receive command signals from the administration device.

13. The method of claim 11, further comprising:
deleting, by the administration device, one signal transmission device from the at least one signal transmission device.

14. The method of claim 11, further comprising:
monitoring, by the administration device, the at least one signal transmission devices, including detecting their activity level, and battery level.

15. The method of claim 11, further comprising:
permitting interaction between the client smart device, by way of a mobile application, with the at least one signal transmission devices, including
scanning for the control signal from a signal transmission device of the at least one signal transmission device;
when the control signal is detected indicating the photography prohibited zone, disabling, by the administration device, the camera function on the client smart device;
displaying, in the administration device, notification that the camera function has been disabled; and
when the control signal indicates that the client smart device is exiting the photography prohibited zone, reactivate the camera function and display a notification that the camera function has been reactivated.

16. The method of claim 11, wherein the at least one signal transmission device is mounted such that it is hidden from view by a user of the client smart device.

17. The method of claim 11, further comprising broadcasting, by the at least one signal transmission device, the control signal as a low energy control signal.

18. The method of claim 11, further comprising monitoring, by the administration device, status of the at least one signal transmission device including transmission of a switching command signal for switching to different photography prohibited zones.

19. The method of claim 11, further comprising transmitting a power command signal to turn on and off, by the administration device, subsets of the at least one signal transmission device for different photography prohibited zones.

20. The method of claim 19, further comprising transmitting a scheduling command signal to turn on and off, by the administration device, the subsets of the at least one signal transmission device according to a schedule of time periods.
